(19) United States
(12) Patent Application Publication
(10) Pub. No.: US 2020/0019352 A1
(43) Pub. Date: Jan. 16, 2020

(54) SMART PRINTER QUEUE MANAGEMENT BASED ON USER LOCATION

(71) Applicant: QUALCOMM Incorporated, San Diego, CA (US)

(72) Inventors: Taruna Agrawal, Cambridge, MA (US); Prasanjit Mondal, Concord, MA (US); Mark Goldwater, Lowell, MA (US)

(21) Appl. No.: 16/031,895

(22) Filed: Jul. 10, 2018

(51) Int. Cl. G06F 3/12

(52) U.S. Cl. CPC G06F 3/1205; G06F 3/1206; G06F 3/1259; G06F 3/1207; G06F 3/1268

(57) ABSTRACT

A printer includes a communication device configured to receive a first print job from a device associated with a first user and to receive location data indicating a position of the first user. The printer also includes a processor coupled to the communication device. The processor is configured to determine a time required to complete the first print job, and to calculate a first threshold distance from the printer based on the time required to complete the first print job. Upon a determination that the position of the first user is greater than the first threshold distance from the printer, the processor delays printing the first print job. Upon a determination that the position of the first user is less than or equal to the first threshold distance from the printer, the processor initiates printing the first print job.

### BACKGROUND

### Field

The present application relates to printer queue management, and more specifically, to systems and methods of managing printer queues based on a user's location.

### Background

In office environments, for example, a number of users may work in close proximity to each other. As a result, office equipment such as printers may be shared among groups of users. At times, users may print documents to shared printers but may not retrieve the printed documents until a later time. This may lead to several problems or inefficiencies.

First, a user who prints a large document on a printer may cause the printing of another user's documents on the same printer to be delayed. If the later user arrives at the printer before the earlier user, the later user may end up waiting unnecessarily for his or her document to be printed. Second, if a user prints a document but does not retrieve the printed document until later, there is a risk that someone else may inadvertently pick up the document or discard the document. In such a situation, the user must print the document again, which leads to a waste of printer resources and the user's time.

### SUMMARY

In one aspect, a printer includes a communication device configured to receive a first print job from a device associated with a first user and to receive location data indicating a position of the first user. The first print job includes data representative of at least one document to be printed. The printer also includes a processor coupled to the communication device. The processor is configured to determine a time required to complete the first print job, and to calculate a first threshold distance from the printer based on the time required to complete the first print job. Upon a determination that the position of the first user is greater than the first threshold distance from the printer, the processor delays printing the at least one document of the first print job. Upon a determination that the position of the first user is less than or equal to the first threshold distance from the printer, the processor initiates printing the at least one document of the first print job.

In another aspect, a method of managing a printer queue includes receiving, at a printer, a first print job from a device associated with a first user, the first print job including data representative of at least one document to be printed. The method also includes receiving, at the printer, location data indicating a position of the first user, determining a time required to complete the first print job, and calculating a first threshold distance from the printer based on the time required to complete the first print job. Upon a determination that the position of the first user is greater than the first threshold distance from the printer, the method delays printing of the at least one document of the first print job. Upon a determination that the position of the first user is less than or equal to the first threshold distance from the printer, the method initiates printing the at least one document of the first print job.

In another aspect, a printer includes means for receiving a first print job from a device associated with a first user, the first print job comprising data representative of at least one document to be printed. The printer also includes means for receiving location data indicating a position of the first user, means for determining a time required to complete the first print job, and means for calculating a first threshold distance from the printer based on the time required to complete the first print job. The printer further includes means for delaying printing the at least one document of the first print job upon a determination that the position of the first user is greater than the first threshold distance from the printer, and means for initiating printing the at least one document of the first print job upon a determination that the position of the first user is less than or equal to the first threshold distance from the printer.

### BRIEF DESCRIPTION OF THE DRAWINGS

Non-limiting and non-exhaustive aspects are described with reference to the following figures in which like parts are labeled with like reference numerals.

FIG. 1 is a block diagram of a system that may dynamically manage a print queue according to an aspect.

FIG. 2 is a block diagram of a printer that may be used with the system of FIG. 1.

FIG. 3 is a block diagram of a mobile device that may be used with the system of FIG. 1.

FIG. 4A is a flow diagram of an example method of dynamically managing a print queue that may be used with the system of FIG. 1.

FIG. 4B is another flow diagram of a method of dynamically managing a print queue that may be used with the system of FIG. 1.

FIG. 5 is an illustration of an indoor map of a geographical location in which the printer of FIG. 1 may be located.

FIG. 6 is an illustration of another indoor map of a geographical location in which the printer of FIG. 1 may be located.

FIG. 7 is a flow diagram of another example method of dynamically managing a print queue that may be used with the system of FIG. 1.

### DETAILED DESCRIPTION

Aspects described herein provide dynamic print queue management based at least in part on a user's location and/or the user's distance to a printer. A user selects at least one document to print using a mobile device. The mobile device transmits data representative of the document, along with a plurality of characteristics relating to the printing of the document (“print characteristics”) (collectively, the “print job”), to the printer. The mobile device also transmits a user or device identifier to the printer to enable the printer to associate the print job with the user and/or mobile device. The mobile device also transmits a print job priority associated with the print job to the printer.

The printer receives data representative of the print job, the identifier, and the print job priority from the mobile device and stores the data in memory. The mobile device also determines a position of the mobile device and transmits data representative of the position to the printer. Alternatively, one or more other devices (e.g., position assistance devices) may assist or otherwise determine the location of the mobile device and may transmit the position to the mobile device. The mobile device may, in turn, transmit data representative of the position of the mobile device to the printer.

The printer calculates a time required to complete the print job (i.e., to print the document(s) of the print job) based on the print characteristics. The printer may then calculate a threshold distance which represents a distance from the printer that, when a user associated with a print job reaches or passes that distance, the printer will begin printing the document(s) of the print job. The threshold distance is based on a walking speed of the user as well as the time required to complete the print job.

The mobile device continually or periodically transmits data representative of the position of the mobile device to the printer. The printer determines whether the user has reached the threshold distance or has passed the threshold distance such that the user is now closer to the printer than the threshold distance. If the user has reached or passed the threshold distance, the printer releases the print job and initiates printing the documents associated with the print job.

If multiple users have transmitted print jobs to the printer, the printer may determine whether to reorder the print jobs to ensure that a higher priority print job is not negatively affected by a lower priority print job. If the printer determines that the current print job is not the highest priority print job, the printer determines the position of the user associated with the highest priority print job (the “highest priority user”) as well as the threshold distance for the highest priority print job. The printer then determines the distance from the highest priority user to the printer and subtracts the threshold distance of the highest priority print job from the distance from the highest priority user to the printer. If the result of the subtraction is less than or equal to the threshold distance of the current user, then the printer determines that the printing of the current user's document will negatively impact the printing of the highest priority user's document. Accordingly, the printer may not release the current user's print job and may reorder the print jobs within the print queue such that the highest priority print job is in line to be released before the current user's print job. On the other hand, if the result of the subtraction is greater than the threshold distance of the current user, then the printer determines that the printing of the current user's document will not negatively impact the printing of the highest priority user's document. Accordingly, the printer may release the current user's print job and initiate printing the current user's print job (i.e., the document(s) associated with the print job).

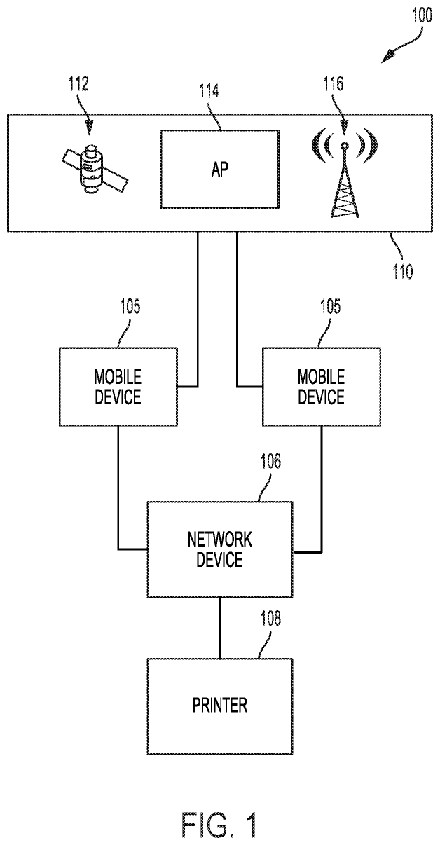

Non-limiting aspects of the disclosure are described below with reference to FIGS. 1-7.

FIG. 1 is a block diagram of an example system 100 that may be used to dynamically and intelligently manage printer queues. In an aspect, system 100 includes a plurality of mobile devices 105 that may connect to a printer 108 through one or more network devices 106. While FIG. 1 illustrates a plurality of mobile devices 105 being in system 100, it should be recognized that any suitable device associated with a user may be used in place of mobile device 105. For example, as described more fully below, devices associated with the user may include a desktop computer or any other suitable device that may connect to printer 108 either directly or through one or more network devices 106. In addition, system 100 may include one or more position assistance devices 110 that may assist or determine a location of the mobile devices 105.

The mobile device 105 may comprise and/or be referred to as a device, a user equipment (UE), a wireless device, a mobile terminal, a terminal, a mobile station (MS), a Secure User Plane Location (SUPL) Enabled Terminal (SET), or by some other name. Moreover, as noted above, mobile device 105 may correspond to any of a variety of devices, including a cellphone, smartphone, laptop, tablet, PDA, wearable device (e.g., smart watch, augmented or mixed reality eyewear, etc.), tracking device, navigation device, Internet of Things (IoT) device, or some other portable or moveable device. The mobile device 105 may support wireless communication with external devices using one or more Radio Access Technologies (RATs), such as using Global System for Mobile Communications (GSM), Code Division Multiple Access (CDMA), Wideband CDMA (WCDMA), Long Term Evolution (LTE), High Rate Packet Data (HRPD), IEEE 802.11 WiFi (also referred to as Wi-Fi), Bluetooth® (BT), Worldwide Interoperability for Microwave Access (WiMAX), 5G new radio (NR) (e.g., using a next generation (NG) radio access network (RAN) (NG-RAN) and 5G core network (5GC)), etc. The mobile device 105 may also support wireless communication using a Wireless Local Area Network (WLAN) which may connect to other networks (e.g. the Internet) using a Digital Subscriber Line (DSL) or packet cable for example. The use of one or more of these RATs may enable the mobile device 105 to communicate with network device 106, printer 108, and/or other devices, and/or enable the network device 106, printer 108, and/or other devices to receive location information regarding the mobile device 105.

The mobile device 105 may comprise a single entity or may comprise multiple entities such as in a personal area network where a user may employ audio, video and/or data I/O devices and/or body sensors and a separate wireline or wireless modem. An estimate of a location of the mobile device 105 may be referred to as a location, location estimate, location fix, fix, position, position estimate or position fix, and may be geographic, thus providing location coordinates for the mobile device 105 (e.g., latitude and longitude) which may or may not include an altitude component (e.g., height above sea level, height above or depth below ground level, floor level or basement level). Alternatively, a location of the mobile device 105 may be expressed as a civic location (e.g., as a postal address or the designation of some point or small area in a building such as a particular room or floor). A location of the mobile device 105 may also be expressed as an area or volume (defined either geographically or in civic form) within which the mobile device 105 is expected to be located with some probability or confidence level (e.g., 67%, 95%, etc.). A location of the mobile device 105 may further be a relative location comprising, for example, a distance and direction or relative X, Y (and Z) coordinates defined relative to some origin at a known location which may be defined geographically, in civic terms, or by reference to a point, area, or volume indicated on a map, floor plan or building plan. In the description contained herein, the use of the term location may comprise any of these variants unless indicated otherwise.

In one aspect, network device 106 is a wireless ethernet router that enables mobile devices to connect to printer 108 using any of the IEEE 802.11 protocols. Alternatively, network device 106 may include any suitable wireless router, access point, gateway, switch, femtocell, base station, mesh network device, etc. Base stations in the 4G domain may comprise evolved Node Bs (eNB). Base stations in the 5G domain (NG-RAN) may comprise NR Node Bs which are more typically referred to as gNBs. Network device 106 enables mobile device 105 to connect to printer 108 or to otherwise transmit data to printer 108 and to receive data from printer 108. The data may include, for example, data representative of one or more documents to print as well as characteristics of the documents to be printed (i.e., print jobs), print job priorities, and location data.

Printer 108 may be a laserjet printer, a multi-function device (e.g., combination printer, scanner, copier, and/or fax machine), a 3D/additive manufacturing printer, a photolithographic printer, and/or any other suitable printer or device that enables a user of a mobile device 105 to print one or more documents.

As used herein, the term “documents” includes word processing documents comprising text and/or images, photos or images themselves, and/or any other two-dimensional arrangement of text and/or images to be imprinted upon cardstock, paper, or the like. In addition, documents may include three-dimensional representations of object to be printed via additive printing, photolithographic printing and/or any other suitable printing technology for creating three-dimensional objects.

When a document is selected to be printed, a print job will be created. The print job includes the data representative of the document to be printed as well as any characteristics (referred to as “print characteristics”) associated with the document and/or print job (as discussed more fully below). The print job may be transmitted from the mobile device to the printer. The printer may temporarily store the print job in a print queue in memory until the print job has been completed (i.e., until the document has been printed according to the associated print characteristics).

Position assistance devices 110 may include one or more satellite vehicles (SVs) 112, one or more wireless access points (APs) 114, and/or one or more antennas, servers, base stations, or other devices of a Radio Access Network (RAN) 116. Position assistance devices 110 may provide position assistance data to mobile device 105 to assist mobile device 105 in determining its position. It should be recognized that network device 106 may provide position assistance data in addition to, or in place of, other position assistance devices and thus may be considered a position assistance device itself in some aspects. Position assistance devices 110 may coordinate with mobile device 105 in determining a location of mobile device 105 using a mobile device (or UE) assisted position method or a mobile device (or UE) based position method as described more fully below.

SVs 112 may include satellites within a GNSS system, such as Global Positioning System (GPS), Galileo, GLONASS, Compass, Quasi-Zenith Satellite System (QZSS), Indian Regional Navigational Satellite System (IRNSS), BeiDOU, and/or any other constellation or constellations. Wireless APs 114 may include routers, switches, hubs, repeaters, range extenders, and/or any other devices that enable mobile device 105 to receive position assistance data through a wireless network. In one aspect, wireless APs 114 include a wireless ethernet router that operates using any of the 802.11 protocols.

In one aspect, RAN 116 includes a 5G network comprising a Next Generation (NG) Radio Access Network (RAN) (NG-RAN) and a 5G Core Network (5GC), which may provide data and voice communication to the mobile device 105. Accordingly, NG-RAN and 5GC may conform to current or future standards for 5G support from 3GPP and/or any other suitable standards organization. RAN 116 may additionally or alternatively include a 4G/LTE RAN that includes one or more eNBs within a Evolved UMTS Terrestrial Radio Access Network (E-UTRAN) as well as an Evolved Packet Core (EPC). Other radio access technologies and topologies may be used in alternative aspects.

It should be noted that FIG. 1 provides only a generalized illustration of various components, any or all of which may be utilized as appropriate, and each of which may be duplicated as necessary. Specifically, although two mobile devices 105 are illustrated in FIG. 1, it will be understood that any suitable number of mobile devices (e.g., one, hundreds, thousands, millions, etc.) may utilize the system 100. Similarly, the system 100 may include a larger (or smaller) number of position assistance devices 110, network devices 106, printers 108, and/or other components. The illustrated connections that connect the various components in the system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality.

With a mobile device assisted position method, mobile device 105 may obtain location measurements and send the measurements to a location server (not shown) for computation of a location estimate for mobile device 105. For example, the location measurements may include techniques based on radio beam angle of direction (AoD) to be described below. The location measurements may also include one or more of a Received Signal Strength Indication (RSSI), Round Trip signal propagation Time (RTT), Reference Signal Time Difference (RSTD), Reference Signal Received Power (RSRP) and/or Reference Signal Received Quality (RSRQ) for gNBs, ng-eNB and/or a WLAN access point (AP). The location measurements may also or instead include measurements of GNSS pseudorange, code phase and/or carrier phase for SVs.

With a mobile device based position method, mobile device 105 may obtain location measurements (e.g., which may be the same as or similar to location measurements for a mobile device assisted position method) and may compute a location of mobile device 105 (e.g. with the help of assistance data received from a location server or broadcast by gNBs, ng-eNB or other base stations or APs). In order to perform the position estimation, the mobile device 105 may have access to information about the expected coverage area of the detected gNB/ng-eNB. Such information may be in form of a list of cell parameters, such as antenna location, radio beam direction, antenna pattern, etc. that are associated with the identity of a cell and/or radio beam. In another example, the coverage area of a cell may be indicated as a bounded geographic area where the cell is expected to be detected. The expected coverage information can be stored in a location server database. mobile device 105 may also receive a list of reference cell and candidate neighbor cells for which to attempt measurements. The mobile device can perform location measurement (e.g., by detecting a cell that transmits the beam, by identifying the beam, etc.) and then report its measurement to a location server. In some examples, the location server can compute the location of mobile device 105 based on the location measurement reported by mobile device 105 and the expected coverage information from the location server database including, for example, antenna locations, radio beam direction, antenna pattern, bounded geographic area, etc. associated with the detected cell and/or the identified radio beam. In some examples, the location server can also compute the location of mobile device 105 based on location measurements reported by other mobile devices that identify the same cell and/or the same beam. For example, the location server may determine, based on the expected coverage information, that the mobile devices including mobile device 105 are in a particular bounded geographic area, and determine the location of mobile device 105 based on the particular bounded geographic area. With a mobile device assisted position method, one or more base stations (e.g. gNBs and/or ng-eNB) or APs may obtain location measurements (e.g., measurements of RSSI, RTT, RSRP, RSRQ or Time Of Arrival (TOA)) for signals transmitted by mobile device 105, and/or may receive measurements obtained by mobile device 105, and may send the measurements to a location server for computation of a location estimate for mobile device 105.

Information provided by a gNB and/or ng-eNB to the location server using NRPPa may include timing and configuration information for transmission of position measurement signals from the gNB and/or location coordinates for the gNB. The location server can then provide some or all of this information to the mobile device 105 as assistance data in an LPP and/or NPP message via the NG-RAN and the 5GC.

An LPP or NPP message sent from the location server to the mobile device 105 may instruct the mobile device 105 to perform any of a variety of tasks, depending on desired functionality. For example, the LPP or NPP message could contain an instruction for the mobile device 105 to obtain measurements for GNSS (or A-GNSS), WLAN, and/or OTDOA (or some other position method). In a case where mobile device 105 is to perform position measurements based on one or more radio beams transmitted by one or more of gNBs, the LPP or NPP message may provide the mobile device 105 with information including, for example, information of the scheduled times when the one or more of gNBs transmit the radio beams, the angles of direction (AoDs) for each radio beam, identification and location information for each radio beam and the antennae (and/or the associated base stations) that transmit the radio beams, etc. mobile device 105 can receive the radio beams and perform position measurements using the information provided by the LPP or NPP message and based on the techniques to be described below. The mobile device 105 may send the measurements back to the location server in an LPP or NPP message (e.g., inside a 5G NAS message) via the serving gNB (or serving ng-eNB) and an Access and Mobility Management Function (AMF), for example.

In some aspects, mobile device 105 may determine, or receive from a position assistance device 110, an uncertainty estimate relating to its position and may transmit the uncertainty estimate to printer 108. The uncertainty estimate may be determined with respect to a distance from the mobile device (e.g., +/−2 meters) in some aspects. Printer 108 may then add the uncertainty estimate to the distance to ensure that the printer has enough time to print the mobile device's document given the mobile device's positional uncertainty as described more fully herein.

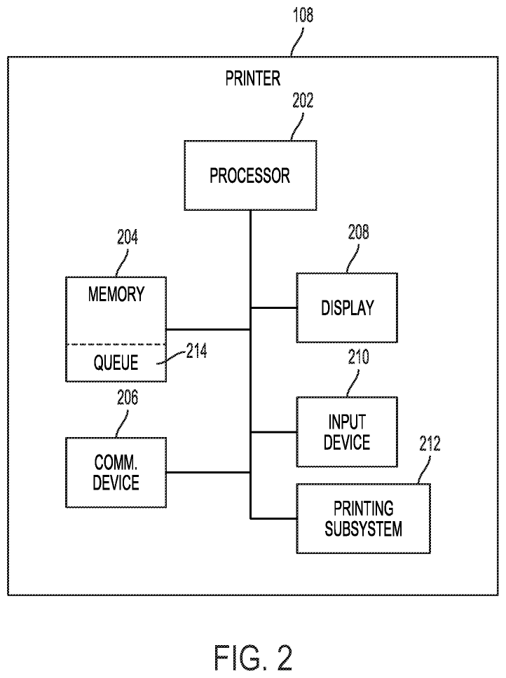

FIG. 2 is a block diagram of a printer 108 according to one aspect. Printer 108 may include a processor 202, a memory 204, a communication device 206, a display 208, an input device 210, and a printing subsystem 212. In the example shown in FIG. 2, each illustrated component of printer 108 is coupled to processor 202 to enable processor 202 to receive data from, and transmit data to, each component. As such, processor 202 is configured to control each component of printer 108.

Processor 202 may include one or more microprocessors, controllers, microcontrollers, field programmable gate arrays (FPGA), application specific integrated circuits (ASIC), and/or any other control circuit that may execute software instructions to perform the functions described herein.

Memory 204 may include one or more non-transitory computer readable media embodied as one or more devices or modules including random access memory (RAM), flash memory, one or more hard disks, and/or any other suitable device capable of storing software instructions for execution by processor 202. Memory 204 may include one or more printer queues 214 for temporarily storing print jobs transmitted to printer 108 from mobile devices 105 or other computers, for example.

While typical printer queues are often set up as a first-in-first-out (FIFO) queue, it should be recognized that the printer queues 214 of the aspects described herein may be dynamic printer queues that enable print jobs to be dynamically reordered and reprioritized by processor 202 based on a variety of factors such as print job priority, a distance to the printer from the mobile device associated with the print job, and print characteristics. The print characteristics may include a number of pages of the document to be printed for the print job, a number of copies of the document to be printed, whether the document is to be printed in duplex, a print quality to be used for printing the document, a resolution of the document, a color depth of the document to be printed (e.g., black and white, 8 bit color, 16 bit color, etc.), and/or any other suitable characteristic of the print job.

Communication device 206 may include a wireless adapter that enables printer 108 to connect to a wireless communication network, or may include a wired adapter that enables printer 108 to connect to a wired communication network. Examples of wireless networks include any IEEE 802.11 compliant network (e.g., 802.11a/b/g/n/ac/ad/ax), a mesh network, a Bluetooth network, a Zigbee network, a RAN, and/or any other suitable wireless network. Examples of wired networks include any IEEE 802.3 network, a powerline network, and/or any other suitable wired network. Communication device 206 enables printer 108 to transmit data to, and receive data from, other network-connected devices, such as mobile devices 105.

Display 208 may include one or more liquid crystal displays (LCDs), light emitting diode (LED) displays, organic LED (OLED) displays, and/or any other suitable display that enables printer to display information to a user.

Input device 210 may include a keypad, keyboard, pointing device, touch-sensitive panel, and/or any other suitable device than enables a user to enter commands or data into printer 108.

Printing subsystem 212 may include a toner assembly, drum assembly, corona wire, fuser, discharge lamp, laser scanning unit, and/or photoreceptor to enable printer to operate as a laser printer. Alternatively, printer 108 may operate as an inkjet printer, a 3D printer, and/or any other suitable printer and may include a corresponding printing subsystem to enable such operation.

Processor 202 controls the various components of printer 108 to receive print jobs, store the print jobs in memory 204, and print the print jobs at a determined time as described more fully herein. In addition, processor 202 controls the components of printer 108 to perform other functions of printer 108 that are described herein. Accordingly, processor 202 of printer 108 constitutes a means for determining a time required to complete the print job, a means for calculating a threshold distance from the printer based on the time required to complete the print job, a means for delaying printing the at least one document of the print job upon a determination that the position of the mobile device is greater than the threshold distance from the printer, and means for initiating printing the at least one document of the print job upon a determination that the position of the mobile device is less than or equal to the threshold distance from the printer. Communication device 206 of printer 108 constitutes means for receiving a print job from a mobile device, the print job comprising data representative of at least one document to be printed, and means for receiving data representative of a position of the mobile device.

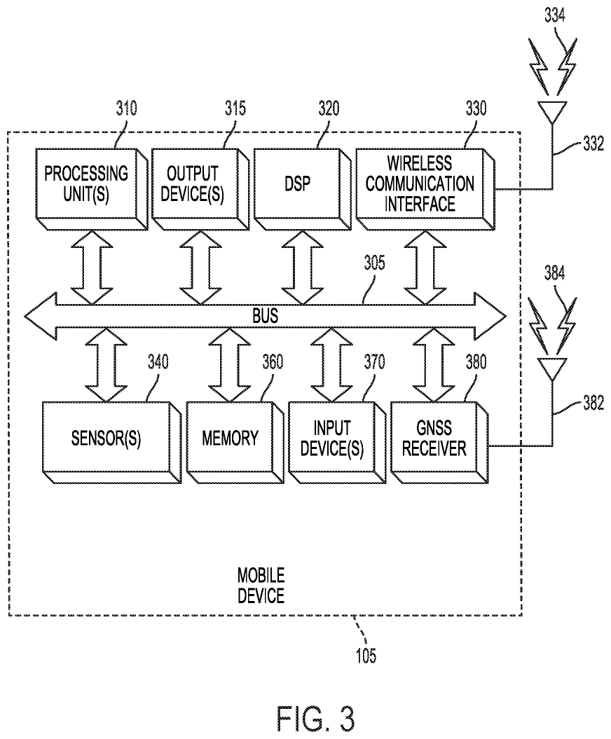

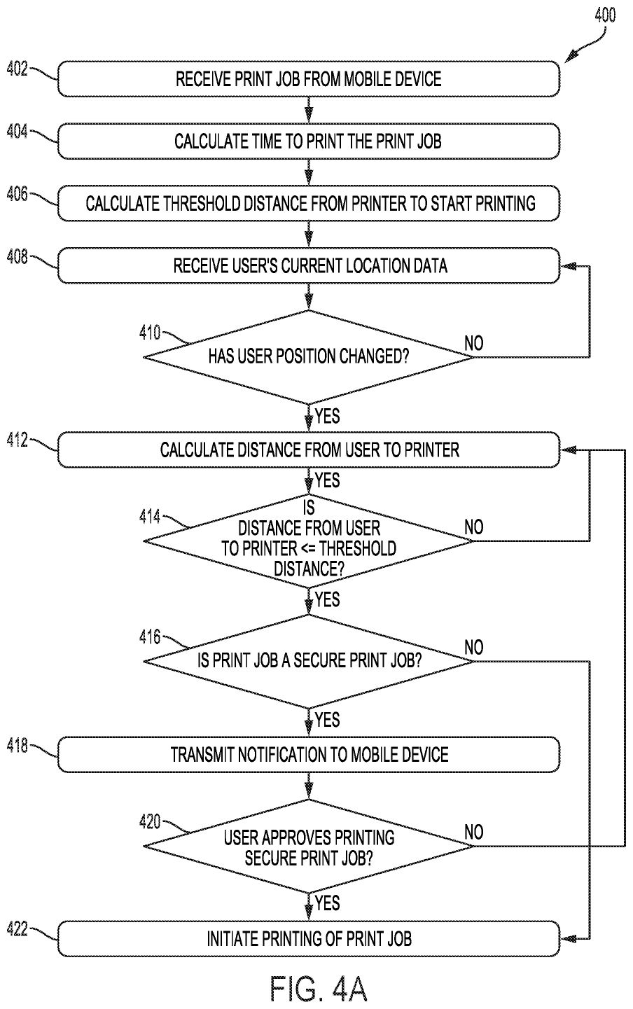

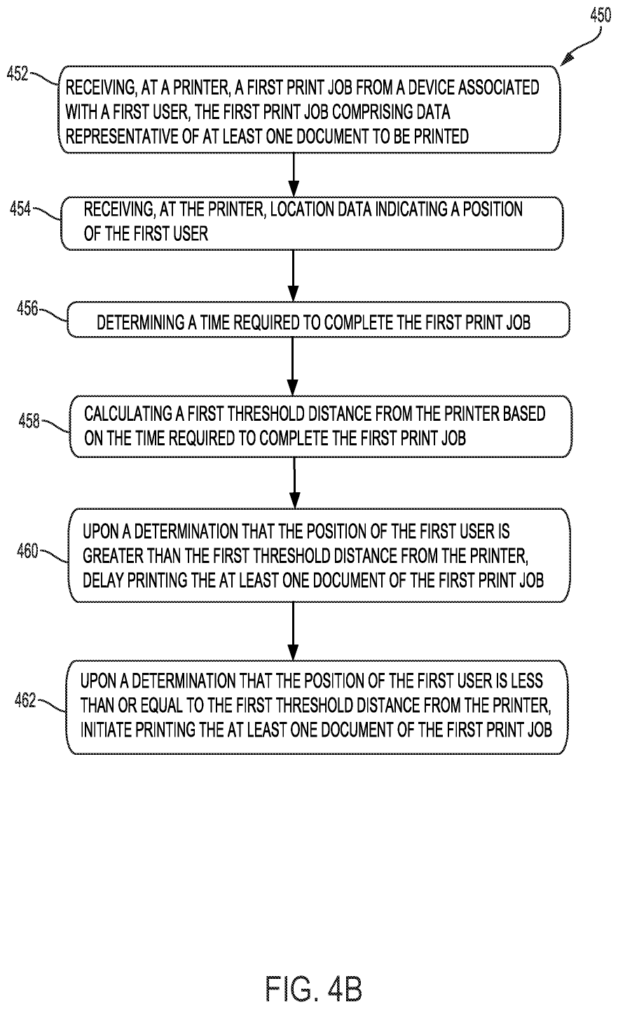

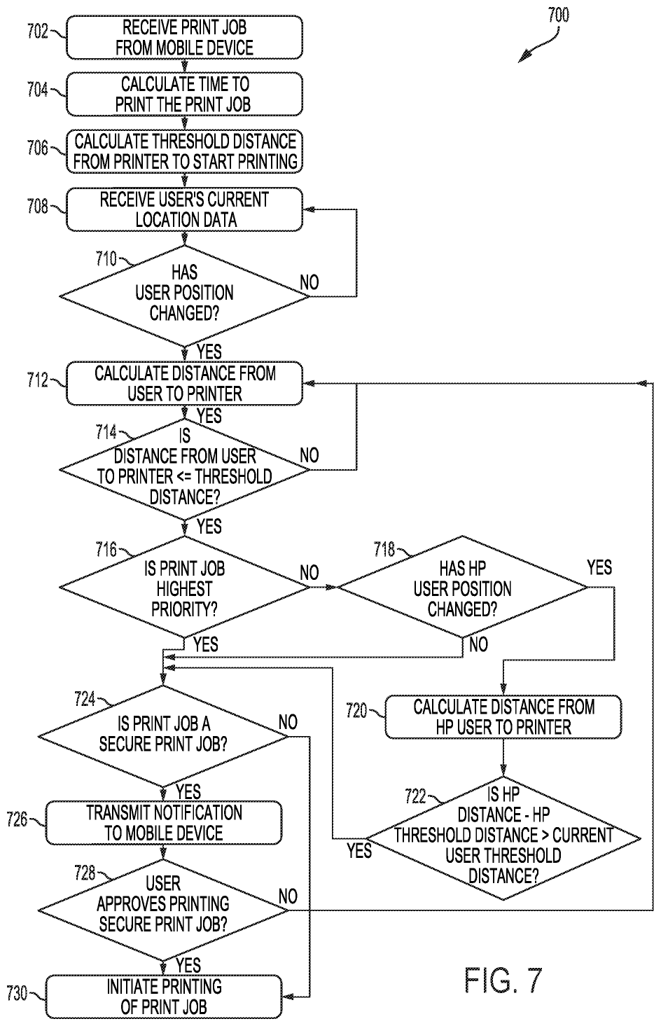

FIG. 3 illustrates an aspect of a mobile device 105, which can be utilized as described herein above (e.g. in association with FIGS. 1-7). For example, the mobile device 105 can perform one or more of the functions of method 400 of FIG. 4A, method 450 of FIG. 4B, and method 700 of FIG. 7. It should be noted that FIG. 3 is meant only to provide a generalized illustration of various components, any or all of which may be utilized as appropriate. It can be noted that, in some instances, components illustrated by FIG. 3 can be localized to a single physical device and/or distributed among various networked devices, which may be disposed at different physical locations (e.g., located at different parts of a user's body, in which case the components may be communicatively connected via a Personal Area Network (PAN) and/or other means).

The mobile device 105 is shown comprising hardware elements that can be electrically coupled via a bus 305 (or may otherwise be in communication, as appropriate). The hardware elements may include a processing unit(s) 310 which can include without limitation one or more general-purpose processors, one or more special-purpose processors (such as digital signal processing (DSP) chips, graphics acceleration processors, application specific integrated circuits (ASICs), and/or the like), and/or other processing structure or means. As shown in FIG. 3, some implementations may have a separate DSP 320, depending on desired functionality. Location determination and/or other determinations based on wireless communication may be provided in the processing unit(s) 310 and/or wireless communication interface 330 (discussed below). The mobile device 105 also can include one or more input devices 370, which can include without limitation a touch screen, a touch pad, microphone, button(s), dial(s), switch(es), and/or the like; and one or more output devices 315, which can include without limitation a display, light emitting diode (LED), speakers, and/or the like.

The mobile device 105 might also include a wireless communication interface 830, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMax device, cellular communication facilities, etc.), and/or the like, which may enable the mobile device 105 to communicate with devices via the networks described above with regard to FIG. 1. The wireless communication interface 330 may permit data to be communicated with a network, eNBs, gNBs, and/or other network components, computer systems, and/or any other electronic devices described herein. The communication can be carried out via one or more wireless communication antenna(s) 332 that send and/or receive wireless signals 334.

Depending on desired functionality, the wireless communication interface 330 may comprise separate transceivers to communicate with base stations (e.g., eNBs and gNBs) and other terrestrial transceivers, such as wireless devices and access points. The mobile device 105 may communicate with different data networks that may comprise various network types. For example, a Wireless Wide Area Network (WWAN) may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16), and so on. A CDMA network may implement one or more radio access technologies (RATs) such as cdma2000, Wideband-CDMA (W-CDMA), and so on. Cdma2000 includes IS-95, IS-2000, and/or IS-856 standards. A TDMA network may implement Global System for Mobile Communications (GSM), Digital Advanced Mobile Phone System (D-AMPS), or some other RAT. An OFDMA network may employ LTE, LTE Advanced, and so on. 5G, LTE, LTE Advanced, GSM, and W-CDMA are described in documents from 3GPP. Cdma2000 is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The mobile device 105 can further include sensor(s) 340. Such sensors may comprise, without limitation, one or more inertial sensors (e.g., accelerometer(s), gyroscope(s), and or other IMUs), camera(s), magnetometer(s), altimeter(s), microphone(s), proximity sensor(s), light sensor(s), and the like, some of which may be used to complement and/or facilitate the position determination described herein.

Aspects of the mobile device 105 may also include a GNSS receiver 380 capable of receiving signals 384 from one or more GNSS satellites (e.g., SVs 112) using an GNSS antenna 382. Such positioning can be utilized to complement and/or incorporate the techniques described herein. The GNSS receiver 380 can extract a position of the mobile device 105, using conventional techniques, from GNSS SVs of a GNSS system, such as Global Positioning System (GPS), Galileo, GLONASS, Compass, Quasi-Zenith Satellite System (QZSS) over Japan, Indian Regional Navigational Satellite System (IRNSS) over India, BeiDOU over China, and/or the like. Moreover, the GNSS receiver 380 can be used by various augmentation systems (e.g., a Satellite Based Augmentation System (SBAS)) that may be associated with or otherwise enabled for use with one or more global and/or regional navigation satellite systems. By way of example, but not limitation, an SBAS may include an augmentation system(s) that provides integrity information, differential corrections, etc., such as, e.g., Wide Area Augmentation System (WAAS), European Geostationary Navigation Overlay Service (EGNOS), Multi-functional Satellite Augmentation System (MSAS), GPS Aided Geo Augmented Navigation or GPS and Geo Augmented Navigation system (GAGAN), and/or the like. Thus, as used herein, a GNSS may include any combination of one or more global and/or regional navigation satellite systems and/or augmentation systems, and GNSS signals may include GNSS, GNSS-like, and/or other signals associated with such one or more GNSS.

The mobile device 105 may further include and/or be in communication with a memory 360. The memory 360 can include, without limitation, local and/or network accessible storage, a disk drive, a drive array, an optical storage device, a solid-state storage device, a random-access memory (“RAM”), and/or a read-only memory (“ROM”), which can be programmable, flash-updateable, and/or the like. The memory 360 may be configured to implement any appropriate data stores, including, without limitation, various file systems, database structures, and/or the like.

The memory 360 of the mobile device 105 also can comprise software elements (not shown in FIG. 3), including an operating system, device drivers, executable libraries, and/or other code, such as one or more application programs, which may comprise computer programs provided by various implementations, and/or may be designed to implement methods, and/or configure systems, provided by other implementations, as described herein. Merely by way of example, one or more procedures described with respect to the method(s) discussed above may be implemented as code and/or instructions executable by the mobile device 105 (and/or processing unit(s) 310 or DSP 320 within mobile device 105). In an aspect, then, such code and/or instructions can be used to configure and/or adapt a general-purpose computer (or other device) to perform one or more operations in accordance with the described methods.

FIG. 4A is a flowchart illustrating a method 400 of dynamically managing a print queue based at least in part on a distance from a printer to a mobile device associated with a print job in the print queue. In the aspect described in FIG. 4A, printer 108 manages the print queue based on print jobs transmitted to printer 108 from a single user's mobile device 105. The steps of method 400 may be implemented by processor 202 of printer 108, such as by executing instructions stored within memory 204.

At block 402, printer 108 receives a print job from a mobile device 105. More specifically, a user of mobile device 105 operates mobile device 105 to select a document to print at printer 108. Mobile device 105 transmits data representative of the document and the print characteristics (collectively referred to as the “print job”) to printer 108. Mobile device 105 also transmits the print job priority to printer 108. Mobile device 105 may also transmit a unique identifier, such as a user ID or device identifier, that identifies the mobile device 105 and/or the user associated with the print job. In one aspect, the unique identifier is anonymized by mobile device 105 or printer 108 to minimize privacy concerns.

At block 404, printer 108 calculates the time required to print the print job based on the print characteristics. For example, processor 202 may access the print job and the print characteristics stored in memory 204. In addition, processor 202 may access a lookup table or other data stored in memory that identifies a number of pages per minute (ppm) that the printer may print as well as different timing adjustments to the ppm number based on each of the other print characteristics. The timing adjustments may include one or more multipliers or discrete timing amounts that may be applied to the ppm number. For example, the timing adjustment may include a multiplier of 2 for duplex printing, a multiplier of 1.1 for printing in a high print quality as compared to a standard print quality, a multiplier of 1 for printing in a black and white color depth, a multiplier of 1.1 for printing in an 8-bit color depth, etc. The timing adjustment may also include a multiplier for the number of copies of the document to be printed, where the multiplier is equal to the number of copies. The above examples are only illustrative, and it should be recognized that any other suitable multiplier may be used for each print characteristic. Once printer 108 has calculated the time required to print the print job, processor 202 stores the calculated time in memory 204 and associates the calculated time with the print job.

At block 406, printer 108 calculates a threshold distance from printer 108 at which to start printing the print job. In one example, printer 108 calculates a distance that is equal to a walking speed of the user multiplied by the time required to print the print job. The walking speed of the user may be an average walking speed of adult humans (e.g., about 1.4 meters per second) that is stored in memory 204, or may be an average speed of the user of the mobile device based on a prior history of the user stored in memory 360 of mobile device 105 that mobile device 105 transmits to printer 108. The prior history of the user's walking speed may be based on data gathered from one or more fitness applications, a pedometer or other sensor of the mobile device, or a device linked to the mobile device (e.g., a wearable computing device, wearable fitness device, etc.), for example.

In one aspect, printer 108 adds a buffer amount to the calculated distance in order to account for variations in the user speed and/or time to print the print job. The buffer amount may be a percentage of the calculated distance (e.g., 10% or 20% of the calculated distance) or may be a predetermined distance (e.g., 5 meters, 10 meters, etc.). The calculated distance plus the buffer amount (if applicable) is referred to herein as the “threshold distance”.

Printer 108 may store the unique identifier, the threshold distance, the print job priority, and the print job together in memory 204. In a specific aspect, the unique identifier, the threshold distance, the print job priority, and the print job may be stored together in the print queue.

At block 408, printer 108 receives data about the user's current position in real time. In one example, mobile device 105 periodically transmits a determined position (sometimes referred to as a “position fix”) of mobile device 105 to printer 108. Mobile device 105 may determine its position using any suitable positioning technology described above. Printer 108 receives the determined position and optionally stores the determined position in memory 204. While mobile device 105 determines its own position (rather than the position of the user) using the techniques described above, it should be recognized that the position of the user is inferred to be substantially the same as the position of mobile device 105 since the user is presumably operating mobile device 105 at the time the position is determined. Therefore, the position of the mobile device 105 is used interchangeably with the position of the user in the aspects described herein unless otherwise specified.

In one aspect, printer 108 may include an additional buffer amount to the threshold distance based on the position data received from mobile device 105. For example, as described above, mobile device 105 may transmit an uncertainty estimate regarding its position to printer 108. Printer 108 may then add an upper boundary of the uncertainty estimate to the buffer amount described above with reference to block 406. For example, if mobile device 105 determines or estimates its position as being accurate within 2 meters (i.e., +/−2 meters), and transmits that uncertainty estimate to printer 108, printer 108 may add the 2 meters to the buffer amount. The buffer amount and the threshold distance are then updated by printer 108 and stored in memory 204.

In some aspects, printer 108 may also determine whether the user has entered a geographical location that printer 108 is located within. For example, if the user is not within the same building as printer 108, printer 108 may wait to determine the user's distance to printer 108 until the user enters the building. As used herein, the term “geographical location” refers to a building, geofence, or other boundary that identifies a point of interest. For example, printer 108 may use a table stored in memory 204 that identifies a range of GPS coordinates (or coordinates based on another reference or measurement frame) included within, or that define a boundary of, the geographical location in which printer 108 resides. Printer 108 may then compare the coordinates of the determined mobile device 105 position with the range of coordinates associated with the geographical location to determine whether the user is within the geographical location.

At block 410, printer 108 determines whether the position of mobile device (i.e., the user position) has changed. For example, printer 108 may compare the current position of the user to a prior-determined position of the user to determine if the user's position has changed. The prior-determined positions of the user may be stored in memory 204 of printer 108 in some aspects. If printer 108 determines that the position of the user has not changed such that the user is substantially stationary, method 400 returns to block 408. On the other hand, if printer 108 determines that the user's position has changed, method 400 continues at block 412.

At block 412, printer 108 calculates a distance from the user to printer 108 based on the current position of the user. In one aspect, printer 108 references a position of printer 108 that is pre-stored in memory 204. For example, memory 204 may include a set of Wi-Fi based coordinates based on a prior position fix of printer 108. Alternatively, memory 204 may include a set of position coordinates based on any other position technology described above. If printer 108 coordinates were determined with respect to a different reference frame than the coordinates of mobile device 105, printer 108 may execute a suitable transform algorithm to transform the coordinates of mobile device 105 to the reference frame of the printer coordinates. Printer 108 may then determine a distance from the user to printer 108 by solving the equation:

D=\sqrt{(x2−x1)²+(y2−y1)²+(z2−z1)²} Equation 1

where D is the distance from the user to the printer, the user's position is identified by the three-dimensional coordinates x2, y2, and z2, and the printer's position is identified by the three-dimensional coordinates x1, y1, and z1. While the coordinates x, y, and z are used in the above equation, it should be recognized that any suitable coordinate system may be used.

At block 414, printer 108 determines whether the distance from printer 108 is less than or equal to the threshold distance calculated above in block 406. If the distance is not less than or equal to the threshold distance (i.e., the distance is greater than the threshold distance), method 400 returns to block 412 without printing the print job. However, if the distance is less than or equal to the threshold distance, method 400 continues at block 416.

At block 416, printer 108 determines whether the print job is a secure print job. As used herein, the term “secure print job” refers to a print job that has at least one document that is not meant to be viewed by other personnel with access to printer 108. Accordingly, secure print jobs may include sensitive, confidential, or otherwise protected content that should be safeguarded by printer 108. In one aspect, the secure status (or lack thereof) of the print job is one of the print characteristics that is transmitted from mobile device 105 to printer 108. Accordingly, in one aspect, the secure status of a print job may be reflected in a flag that is set, a variable having a value corresponding to a secure status, or the like, that is transmitted from mobile device 105 to printer 108 and stored in memory 204 of printer 108. If printer 108 determines that the print job is not a secure print job, method 400 continues at block 422. However, if printer 108 determines that the print job is a secure print job, method 400 continues at block 418.

At block 418, printer 108 transmits a notification to the user's mobile device 105 that the secure print job is ready to print. At block 420, mobile device 105 displays a prompt to the user in response to the notification. The prompt may inform the user that the secure print job is ready to print (based on the distance from the user to printer 108) and that the user should approve the printing of the secure print job for the secure print job to be printed. A prompt may be presented to the user as well as an input mechanism to receive the user's input to approve, cancel, or delay the printing of the secure print job. In one aspect, a password or other security challenge must be successfully input by the user to enable the secure print job to be approved. If the user inputs a command to approve the printing of the secure print job, mobile device 105 transmits an approval message to printer 108 to enable printer 108 to print the secure print job. In response, method 400 continues at block 422. If the user does not approve the printing of the secure print job (i.e., cancels or delays the printing of the secure print job), or if a predetermined period of time elapses without receiving the user's approval, mobile device 105 may either transmit a message disapproving of the printing of the secure print job or may refrain from transmitting the approval message to printer 108. In either scenario, printer 108 will not print the secure print job. If the user has delayed (and not canceled) the print job, method 400 returns to block 412. In one aspect, printer 108 will add a predetermined delay before returning to block 412 and calculating a new distance from the user to printer 108.

At block 422, printer 108 initiates printing of the print job. After the print job has completed (e.g., after all documents have been printed), method 400 ends.

FIG. 4B is a flowchart illustrating a method 450 of dynamically managing a print queue based at least in part on a distance from a printer to a mobile device associated with a print job in the print queue. In the aspect described in FIG. 4B, printer 108 manages the print queue based on print jobs transmitted to printer 108 from a single user's mobile device 105. The steps of method 450 may be implemented by processor 202 of printer 108, such as by executing instructions stored within memory 204.

At block 452, printer 108 receives a first print job from a device associated with a first user. The print job includes data representative of at least one document to be printed. The device associated with the first user may be a mobile device 105, or may be a desktop computer or any other suitable device that may transmit a print job to the printer 108. The device also transmits the print job priority to printer 108. The device may also transmit a unique identifier, such as a user ID or device identifier, that identifies the device and/or the user associated with the print job. In one aspect, the unique identifier is anonymized by the device or printer 108 to minimize privacy concerns.

At block 454, printer 108 receives location data indicating a position of the first user. The position of the first user may be determined by a mobile device 105 carried by the user as described above. For example, the mobile device 105 may receive and/or determine a position of the mobile device according to the location technologies described above with reference to FIG. 1. Since the user is assumed to be carrying the mobile device 105, the position of the mobile device 105 is equated with the position of the user. The mobile device 105 may then transmit location data to the printer 108 indicating the position of the mobile device (and thereby, the position of the user).

At block 456, printer 108 calculates the time required to print the first print job based on the print characteristics. For example, processor 202 may access the print job and the print characteristics stored in memory 204 and may calculate the time required to print the first print job in a similar manner as described in block 404 (shown in FIG. 4A). Once printer 108 has calculated the time required to print the print job, processor 202 stores the calculated time in memory 204 and associates the calculated time with the print job.

At block 458, printer 108 calculates a first threshold distance from printer 108 based on the time required to complete the first print job. The first threshold distance represents a distance from printer 108 that a user should be less than or equal to in order for printer 108 to start printing the print job associated with the user. In one example, printer 108 calculates the threshold distance in a similar manner as described in block 406 (shown in FIG. 4A). Printer 108 may store the unique identifier, the threshold distance, the print job priority, and the print job together in memory 204. In a specific aspect, the unique identifier, the threshold distance, the print job priority, and the print job may be stored together in the print queue.

At block 460, printer 108 determines whether the position of the first user is greater than the first threshold distance from printer 108. Upon a determination that the position of the first user is greater than the first threshold distance from printer 108, printer 108 delays printing the at least one document of the first print job. On the other hand, upon a determination that the position of the first user is less than or equal to the first threshold distance from printer 108, printer 108 initiates printing the at least one document of the first print job at block 462.

At block 414, printer 108 determines whether the distance from printer 108 is less than or equal to the threshold distance calculated above in block 406. If the distance is not less than or equal to the threshold distance (i.e., the distance is greater than the threshold distance), method 400 returns to block 412 without printing the print job. However, if the distance is less than or equal to the threshold distance, method 400 continues at block 416.

It should be recognized that, in some implementations, additional blocks and features from FIG. 4A, as well as from the other figures of the specification, may optionally be included in method 450 as desired.

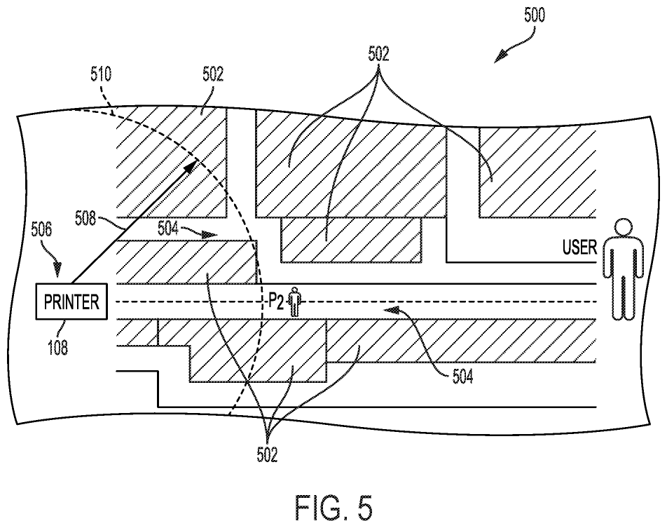

FIG. 5 illustrates an example indoor map 500 of a geographical location in which printer 108 is located. In the aspect illustrated in FIG. 5, the geographical location is an office building. However, it should be recognized that any suitable geographical location may be used. As shown in FIG. 5, the geographical location includes a plurality of obstacles 502, such as walls, and at least one path 504 around or between the obstacles 502.

Printer 108 is positioned in a first position 506 within the geographical location. In a specific aspect, printer 108 is fixedly placed in the first position 506 such that printer 108 does not move in position. The user, on the other hand, moves in position as the user travels toward one or more destinations, including to the printer 108 to retrieve one or more printed documents. In the aspect shown in FIG. 5, printer 108 may not be aware of the details of map 500, such as the obstacles 502 and paths 504 identified in map 500.

To facilitate the efficient management of the printer queue, printer 108 calculates a threshold distance 508 from printer 108 as describe above with reference to block 406. As described above, each print job may have a different threshold distance associated therewith since printer 108 calculates the threshold distance based at least in part on the print characteristics of each print job. Printer 108 may hold or otherwise prevent a print job from printing until the user associated with the print job is equal to or less than the threshold distance away from printer 108. When printer 108 determines that the user is less than or equal to the threshold distance away from printer 108, printer 108 releases the print job and begins printing the print job (unless the print job is a secure print job as described above).

In another aspect, printer 108 uses the calculated threshold distance to establish a geofence 510 around printer 108. The geofence 510 may be arranged as a circle around printer 108 with printer 108 in the center and the threshold distance being the radius of the circle. Alternatively, the geofence 510 may be arranged as any other suitable shape or combination of shapes. If printer 108 determines that the position of the user has crossed the geofence 510, printer 108 may release the print job and begin printing the associated document or documents.

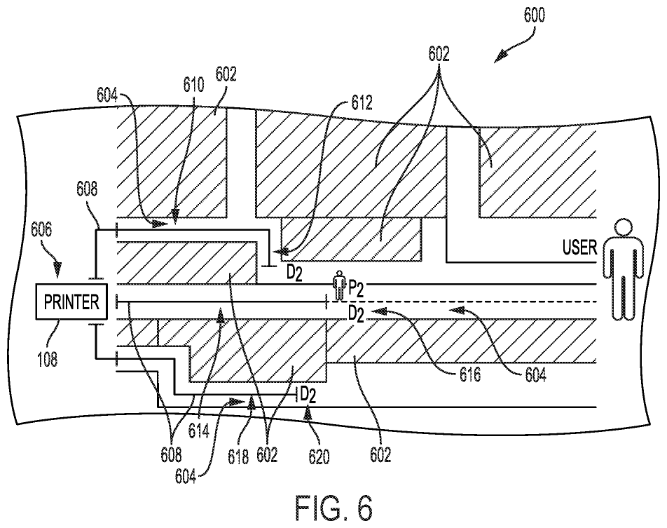

FIG. 6 illustrates another example indoor map 600 of a geographical location in which printer 108 is located. In the aspect illustrated in FIG. 6, the geographical location is an office building. However, it should be recognized that any suitable geographical location may be used. In a similar manner as described above, the geographical location includes a plurality of obstacles 602, such as walls, and at least one path 604 around or between the obstacles 602.

Printer 108 is positioned in a first position 606 within the geographical location. In a specific aspect, printer 108 is fixedly placed in the first position 606 such that printer 108 does not move in position. The user, on the other hand, moves in position as the user travels toward one or more destinations, including to the printer 108 to retrieve one or more printed documents.

In the aspect shown in FIG. 6 and in contrast to the aspect shown in FIG. 5, printer 108 is aware of the details of map 600, such as the obstacles 602 and paths 604 identified in map 600. For example, data representative of map 600 may be stored in memory 204 of printer 108 and may be accessed by processor 202 to identify the various paths 604 through obstacles 602 to printer 108.

To facilitate the efficient management of the printer queue, printer 108 calculates a threshold distance 608 from printer 108 as described in FIG. 3 with reference to block 406. As described above, each print job may have a different threshold distance associated therewith since printer 108 calculates the threshold distance based at least in part on the print characteristics of each print job. More specifically, in the implementation shown in FIG. 6, printer 108 may calculate a threshold distance for a print job and may identify a location along each path that corresponds to the threshold distance from printer 108. In this implementation, the location is not determined according to a radius or a straight line originating from printer 108. Rather, the location is determined based on a distance traveled by a user as the user walks around obstacles 602 toward printer 108 (hereinafter referred to as a “travel distance”) until the user has traveled the threshold distance. Accordingly, for a first path 610, printer 108 may determine a first location 612 that is the travel distance from printer 108. For example, if printer 108 calculates threshold distance 608 to be 20 meters, the first location 610 may be a location at the end of a path that extends 2 meters north of printer 108, 16 meters east, and 2 meters south. For a second path 614, printer 108 may determine a second location 616 that is the travel distance from printer 108. Using the same example threshold distance 608 of 20 meters, the second location 616 may be a location at the end of a path that extends 20 meters east of printer 108. For a third path 618, printer 108 may determine a third location 620 that is the travel distance from printer 108. For example, if printer 108 calculates threshold distance 608 to be 20 meters, the third location 620 may be a location at the end of a path that extends 1 meter south of printer 108, 4 meters east, 1 meter south, and 14 meters east. It should be recognized that these examples are merely for illustration, and any suitable distances, paths, and locations may be used.

Printer 108 may hold or otherwise prevent a print job from printing until the user associated with the print job is equal to or less than the threshold distance away from printer 108 (i.e., the user has reached the respective location for one of the paths to printer 108). When printer 108 determines that the user is less than or equal to the threshold distance away from printer 108, printer 108 releases the print job and begins printing the print job (unless the print job is a secure print job as described above).

FIG. 7 is a flowchart illustrating a method 700 of dynamically managing a print queue based at least in part on a distance from a printer to a mobile device associated with a print job in the print queue. The steps of method 700 may be implemented by processor 202 of printer 108, such as by executing instructions stored within memory 204.

In the aspect described in FIG. 7, printer 108 manages the print queue based on print jobs transmitted to printer 108 from a plurality of users' mobile devices 105. As described more fully herein, printer 108 does not necessarily release print jobs in the multiple print job scenario based on which user is first to cross the threshold distance associated with that user's print job. Rather, in an aspect, printer 108 may only allow a low priority print job to be released from the print queue when the low priority print job will take less amount of time to print than a time it will take for a user with a higher priority print job to reach the threshold distance associated with the higher priority print job. Otherwise, if the user with a higher priority print job is expected to reach his or her threshold distance before printer 108 is expected to be able to print a lower priority print job, printer 108 may reorder the higher priority print job such that the higher priority print job is printed first.

At block 702, printer 108 receives one or more print jobs from a plurality of mobile devices 105. For example, a user of mobile device 105 (sometimes referred to herein as a “current user” to differentiate from the rest of the plurality of users) operates mobile device 105 to select a document to print at printer 108. Mobile device 105 transmits data representative of the print job (i.e., the document to be printed and the print characteristics) to printer 108. Mobile device 105 also transmits the print job priority to printer 108. Mobile device 105 may also transmit a unique identifier, such as a user ID or device identifier, that identifies the mobile device 105 and/or the user associated with the print job. In one aspect, the unique identifier is anonymized by mobile device 105 or printer 108 to minimize privacy concerns.

At block 704, printer 108 calculates the time required to print each print job based on the print characteristics. For example, processor 202 may access the print job and the print characteristics stored in memory 204. In addition, processor 202 may access a lookup table or other data stored in memory that identifies a number of pages per minute (ppm) that the printer may print as well as different timing adjustments to the ppm number based on each of the other print characteristics. The timing adjustments may include one or more multipliers or discrete timing amounts that may be applied to the ppm number. For example, the timing adjustment may include a multiplier of 2 for duplex printing, a multiplier of 1.1 for printing in a high print quality as compared to a standard print quality, a multiplier of 1 for printing in a black and white color depth, a multiplier of 1.1 for printing in an 8-bit color depth, etc. The timing adjustment may also include a multiplier for the number of copies of the document to be printed, where the multiplier is equal to the number of copies. The above examples are only illustrative, and it should be recognized that any other suitable multiplier may be used for each print characteristic. Once printer 108 has calculated the time required to print the print job, processor 202 stores the calculated time in memory 204 and associates the calculated time with the print job.

At block 706, printer 108 calculates a threshold distance from printer 108 at which to start printing each print job. In one example, printer 108 calculates a distance that is equal to a walking speed of the user multiplied by the time required to print the print job. The speed of the user may be an average walking speed of adult humans (e.g., about 1.4 meters per second) that is stored in memory 204, or may be an average speed of the user of the mobile device based on a prior history of the user stored in memory 360 that mobile device 105 transmits to printer 108. The prior history of the user's walking speed may be based on data gathered from one or more fitness applications, a pedometer or other sensor of the mobile device, or a device linked to the mobile device (e.g., a wearable computing device, wearable fitness device, etc.), for example.

In one aspect, printer 108 adds a buffer amount to the calculated distance in order to account for variations in the user speed and/or time to print the print job. The buffer amount may be a percentage of the calculated distance (e.g., 10% or 20% of the calculated distance) or may be a predetermined distance (e.g., 5 meters, 10 meters, etc.). The calculated distance plus the buffer amount (if applicable) is referred to herein as the “threshold distance”.

Printer 108 may store the unique identifier, the threshold distance, the print job priority, and the print job together in memory 204. In a specific aspect, the unique identifier, the threshold distance, the print job priority, and the print job may be stored together in the print queue.

At block 708, printer 108 receives data about the user's current position in real time. In addition, printer 108 receives data about each other user that has submitted a print job to printer 108. In one example, mobile device 105 periodically transmits a determined position of mobile device 105 to printer 108. Mobile device 105 may determines its position using any suitable positioning technology described above. Printer 108 receives the determined position and optionally stores the determined position in memory 204. While mobile device 105 determines its own position (rather than the position of the user) using the techniques described above, it should be recognized that the position of the user is inferred to be substantially the same as the position of mobile device 105 since the user is presumably operating mobile device 105 at the time the position is determined. Therefore, the position of the mobile device 105 is used interchangeably with the position of the user in the aspects described herein unless otherwise specified.

Printer 108 may also update the buffer amount and the threshold distance based on position data received from the mobile device 105, such as an uncertainty estimate of the mobile device 105 as described above with reference to FIG. 4. In some aspects, printer 108 may also determine whether the user has entered the same geographical location that printer is located within in a similar manner as described above with reference to FIG. 4.

At block 710, printer 108 determines whether the position of mobile device (i.e., the user position) has changed. For example, printer 108 may compare the current position of the user to a prior-determined position of the user to determine if the user's position has changed. The prior-determined positions of the user may be stored in memory 204 of printer 108 in some aspects. If printer 108 determines that the position of the user has not changed such that the user is substantially stationary, method 700 returns to block 708. On the other hand, if printer 108 determines that the user's position has changed, method 700 continues at block 712.

At block 712, printer 108 calculates a distance from the user to printer 108 based on the current position of the user. In one aspect, printer 108 references a position of printer 108 that is pre-stored in memory 204. For example, memory 204 may include a set of Wi-Fi based coordinates based on a prior position fix of printer 108. Alternatively, memory 204 may include a set of position coordinates based on any other position technology described above. If printer 108 coordinates were determined with respect to a different reference frame than the coordinates of mobile device 105, printer 108 may execute a suitable transform algorithm to transform the coordinates of mobile device 105 to the reference frame of the printer coordinates. Printer 108 may then determine a distance from the user to printer 108 by solving Equation 1 above.

At block 714, printer 108 determines whether the distance from printer 108 is less than or equal to the threshold distance calculated above in block 706. If the distance is not less than or equal to the threshold distance (i.e., the distance is greater than the threshold distance), method 700 returns to block 712 without printing the print job. However, if the distance is less than or equal to the threshold distance, method 700 continues at block 716.

At block 716, printer 108 determines whether the print job associated with the user is the highest priority print job in the print queue. If the print job is the highest priority print job, method 700 continues at block 724 below. However, if the print job is not the highest priority print job, method 700 continues at block 718.

At block 718, printer 108 determines whether the user associated with the highest priority print job (hereinafter referred to as the “highest priority user”) in the print queue has changed position based on the determination at block 710. If the user associated with the highest priority print job has not changed position, method 700 enables the current user's print job to continue at block 724. However, if the highest priority user's position has changed, printer 108 calculates the distance from the highest priority user to printer 108 at block 720 based on the determined position of the highest priority user.

Printer 108 then determines whether to reorder one or more print jobs within the print queue. More specifically, at block 722, printer 108 determines whether a result of subtracting the highest priority user's threshold distance from the highest priority user's distance is greater than the current user's threshold distance. If so, then that means the highest priority user is still far enough away from the printer 108 such that the printing of the current user's print job will not affect the printing of the highest priority user's print job. In other words, the current user's print job is expected to complete printing before the highest priority user's print job is expected to start printing. Accordingly, method 700 moves to block 724 to determine whether the current user's print job is a secure print job. On the other hand, if the result of subtracting the highest priority user's threshold distance from the highest priority user's distance is less than or equal to the current user's threshold distance, then that means the printing of the current user's print job may adversely affect the printing of the highest priority user's print job (i.e., the highest priority user's print job may be delayed such that the highest priority user may reach the location of the printer 108 before his or her print job has completed printing). In this situation, method 700 does not release the current user's print job and reorders the higher priority print job to be released before the current user's print job. Method 700 then returns to block 712 to allow a higher priority print job to be printed.

It should be recognized that blocks 718, 720, and 722 may be repeated for each print job that has a higher priority than the print job of the current user. Accordingly, if any higher priority print job satisfies the criterion of block 722, that print job may be dynamically reordered within the print queue and may be released before the current user's print job.

Referring to block 724, if the current user's print job is not a secure print job, method 700 moves to block 730 to release the print job and initiate the printing of the print job. On the other hand, if printer 108 determines that the print job is a secure print job, method 700 continues at block 726.

At block 726, printer 108 transmits a notification to user that the secure print job is ready to print. At block 728, mobile device 105 displays a prompt to the user in response to the notification. The prompt may inform the user that the secure print job is ready to print (based on the distance from the user to printer 108) and that the user should approve the printing of the secure print job for the secure print job to be printed. A prompt may be presented to the user as well as an input mechanism to receive the user's input to approve, cancel, or delay the printing of the secure print job. In one aspect, a password or other security challenge must be successfully input by the user to enable the secure print job to be approved. If the user inputs a command to approve the printing of the secure print job, mobile device 105 transmits an approval message to printer 108 to enable printer 108 to print the secure print job. In response, method 700 continues at block 730. If the user does not approve the printing of the secure print job (i.e., cancels or delays the printing of the secure print job), or if a predetermined period of time elapses without receiving the user's approval, mobile device 105 may either transmit a message disapproving of the printing of the secure print job or may refrain from transmitting the approval message to printer 108. In either scenario, printer 108 will not print the secure print job. If the user delays the print job (and does not cancel the print job), method 700 returns to block 712. In one aspect, printer 108 will add a predetermined delay before returning to block 712 and calculating a new distance from the user to printer 108.

At block 730, printer 108 initiates printing of the print job. After the print job has completed (e.g., after all documents have been printed), method 700 ends.

While the foregoing aspects have been described with reference to printing one or more documents from a mobile device, it should be recognized that the documents of a print job may be printed from any suitable device including a desktop computer. The desktop computer may be remote from the printer 108 (e.g., in a different building or geographical location than printer 108) or may be in the same geographical location as printer 108. In the event that a user prints from a desktop computer, the desktop printer may transmit the user identifier discussed above to printer 108 along with the print job. If the user has a mobile device 105 that is linked to the same user identifier, the desktop computer (or the mobile device 105) may transmit a notification to printer 108 that the mobile device 105 is linked to the user identifier (and therefore to the print job). Printer 108 may then track the location of the mobile device 105 as described above to enable the printer queue management of the print job described above. Accordingly, a print job initiated from a desktop computer may be “handed off” to the mobile device 105 to enable the printer 108 to track the position of the mobile device 105 and initiate printing of the print job when the user reaches the threshold distance associated with the print job. It should be recognized that other stationary computing devices may be used instead of the desktop computer in this example.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the concepts described herein. Therefore, it is intended that claimed subject matter not be limited to the particular examples disclosed, but that such claimed subject matter may also include all aspects falling within the scope of the appended claims, and equivalents thereof.

In addition, it should be recognized that the aspects described herein may be combined together or split apart as desired. For example, the steps of some methods may be incorporated into other methods, and components of some devices may be incorporated into other devices as desired.

The terms, “and,” and “or” as used herein may include a variety of meanings that will depend at least in part upon the context in which it is used. Typically, “or” if used to associate a list, such as A, B or C, is intended to mean A, B, and C, here used in the inclusive sense, as well as A, B or C, here used in the exclusive sense. Reference throughout this specification to “one example” or “an example” means that a particular feature, structure, or characteristic described in connection with the example is included in at least one example of claimed subject matter. Thus, the appearances of the phrase “in one example” or “an example” in various places throughout this specification are not necessarily all referring to the same example. Furthermore, the particular features, structures, or characteristics may be combined in one or more examples. Examples described herein may include machines, devices, engines, or apparatuses that operate using digital signals. Such signals may comprise electronic signals, optical signals, electromagnetic signals, or any form of energy that provides information between locations.

1. A printer comprising:
a communication device configured to:
receive a first print job from a device associated with a first user, the first print job comprising data representative of at least one document to be printed; and
receive location data indicating a position of the first user;
a processor coupled to the communication device, the processor configured to:
determine a time required to complete the first print job;
calculate a first threshold distance from the printer based on the time required to complete the first print job;
calculate a distance from the first user to the printer based on the position of the first user;
determine whether the first print job is a secure print job;
upon a determination that the first print job is not a secure print job, delay printing the at least one document of the first print job until the distance from the first user to the printer is less than or equal to the first threshold distance from the printer; and
upon a determination that the first print job is a secure print job, delay printing the at least one document of the first print job until the distance from the first user to the printer is less than or equal to the first threshold distance from the printer and until the first user has released the first print job.

2. The printer of claim 1, wherein a mobile device associated with the first user is configured to determine the position of the first user, and wherein the communication device is further configured to receive the location data indicating the position of the first user from the mobile device.

3. The printer of claim 1, wherein the communication device is configured to receive a second print job from a second user after the first print job is received, and wherein the processor is configured to store the second print job in a print queue to be released after the first print job.

4. The printer of claim 3, wherein the communication device is configured to:
receive location data indicating a position of the second user;
calculate a second threshold distance from the printer based on a time required to complete the second print job; and
calculate a distance from the second user to the printer based on the position of the second user.

5. The printer of claim 4, wherein the processor is configured to reorder the second print job to be released before the first print job upon a determination that the distance from the second user to the printer minus the second threshold distance is less than or equal to the first threshold distance.

6. The printer of claim 5, wherein the first print job has a first priority and the second print job has a second priority, and wherein the printer is configured to reorder the second print job to be released before the first print job upon a determination that the second priority is higher than the first priority and that the distance from the second user to the printer minus the second threshold distance is less than or equal to the first threshold distance.

7. The printer of claim 1, wherein the processor is further configured to determine the time required to complete the first print job based at least in part on a plurality of print characteristics transmitted from the device associated with the first user to the printer.

8. The printer of claim 1, wherein the communication device is further configured to receive a user identifier and a print job priority for the first print job from the device associated with the first user, and wherein the processor is configured to store the first print job along with the user identifier and the print job priority in a memory of the printer.

9. The printer of claim 1, further comprising a memory that stores a map of a geographical location in which the printer is located, wherein the map includes data representative of a plurality of obstacles and a plurality of paths to the printer that avoid the obstacles.

10. The printer of claim 9, wherein the processor is configured to determine a location on a first path of the plurality of paths, wherein the first path avoids at least one obstacle of the plurality of obstacles, and wherein a travel distance along the path to the location is equal to the first threshold distance.

11. The printer of claim 10, wherein the processor is configured to release the first print job when the first user is determined to have reached the location.

12. A method of managing a printer queue, the method comprising:
receiving, at a printer, a first print job from a device associated with a first user, the first print job including data representative of at least one document to be printed; and
receiving, at the printer, location data indicating a position of the first user;
determining a time required to complete the first print job;
calculating a first threshold distance from the printer based on the time required to complete the first print job;
calculating a distance from the first user to the printer based on the position of the first user;
determining whether the first print job is a secure print job;
upon a determination that the first print job is not a secure print job, delaying printing the at least one document of the first print job until the distance from the first user to the printer is less than or equal to the first threshold distance from the printer; and
upon a determination that the first print job is a secure print job, delaying printing the at least one document of the first print job until the distance from the first user to the printer is less than or equal to the first threshold distance from the printer and until the first user has released the first print job.

13. The method of claim 12, wherein a mobile device associated with the first user is configured to determine the position of the first user, and wherein the method further comprises receiving the location data indicating the position of the first user from the mobile device.

14. The method of claim 12, the method further comprising receiving a second print job from a second user after the first print job is received, and storing the second print job in a print queue to be released after the first print job.

15. The method of claim 14, the method further comprising:
receiving location data indicating a position of the second user;
calculating a second threshold distance from the printer based on a time required to complete the second print job; and
calculating a distance from the second user to the printer based on the position of the second user.

16. The method of claim 15, further comprising reordering the second print job to be released before the first print job upon a determination that the distance from the second user to the printer minus the second threshold distance is less than or equal to the first threshold distance.

17. The method of claim 16, wherein the first print job has a first priority and the second print job has a second priority, the method further comprising reordering the second print job to be released before the first print job upon a determination that the second priority is higher than the first priority.

18. The method of claim 13, further comprising receiving a user identifier and a print job priority for the first print job from the mobile device, and storing the first print job along with the user identifier and the print job priority in a memory of the printer.

19. The method of claim 12, further comprising storing a map of a geographical location in which the printer is located within a memory of the printer, wherein the map includes data representative of a plurality of obstacles and a plurality of paths to the printer that avoid the obstacles.

20. The method of claim 19, further comprising determining a location on a first path of the plurality of paths, wherein the first path avoids at least one obstacle of the plurality of obstacles, and wherein a travel distance along the path to the location is equal to the threshold distance.

21. The method of claim 20, further comprising releasing the first print job when the user is determined to have reached the location.

22. A printer comprising:
means for receiving a first print job from a device associated with a first user, the first print job comprising data representative of at least one document to be printed;
means for receiving location data indicating a position of the first user;
means for determining a time required to complete the first print job;
means for calculating a first threshold distance from the printer based on the time required to complete the first print job;
means for calculating a distance from the first user to the printer based on the position of the first user;
means for determining whether the first print job is a secure print job;
means for delaying printing the at least one document of the first print job until the distance from the first user to the printer is less than or equal to the first threshold distance from the printer upon a determination that the first print job is not a secure print job; and
means for delaying printing the at least one document of the first print job until the distance from the first user to the printer is less than or equal to the first threshold distance from the printer and until the first user has released the first print job, upon a determination that the first print job is a secure print job.

23. The printer of claim 22, wherein the means for receiving the first print job is configured to receive a second print job from a second user after the first print job is received, and wherein the second print job is stored in a print queue to be released after the first print job.

24. The printer of claim 23, wherein the means for receiving the location data is configured to receive location data indicating a position of a second user and wherein the means for calculating the first threshold distance is configured to calculate a second threshold distance from the printer based on a time required to complete the second print job.

25. The printer of claim 24, wherein the printer is configured to reorder the second print job to be released before the first print job upon a determination that the distance from the second user to the printer minus the second threshold distance is less than or equal to the first threshold distance.

26. The printer of claim 25, wherein the first print job has a first priority and the second print job has a second priority, and wherein the printer is configured to reorder the second print job to be released before the first print job upon a determination that the second priority is higher than the first priority and that the distance from the second user to the printer minus the second threshold distance is less than or equal to the first threshold distance.

27. The printer of claim 22, wherein the means for determining the time required to complete the first print job is configured to determine the time required to complete the first print job based at least in part on a plurality of print characteristics transmitted from the device associated with the first user to the printer.

28. The printer of claim 22, further comprising a memory that stores a map of a geographical location in which the printer is located, wherein the map includes data representative of a plurality of obstacles and a plurality of paths to the printer that avoid the obstacles.

29. The printer of claim 28, wherein the printer is configured to determine a location on a first path of the plurality of paths, wherein the first path avoids at least one obstacle of the plurality of obstacles, and wherein a travel distance along the path to the location is equal to the first threshold distance.

30. The printer of claim 29, wherein the means for initiating printing the at least one document of the first print job is configured to release the first print job when the first user is determined to have reached the location.
